(19) United States
(12) Patent Application Publication
(10) Pub. No.: US 2013/0097903 A1
(43) Pub. Date: Apr. 25, 2013

(54) End Stand Display System and Side Saddle Display and Product Holder

(71) Applicant: Menasha Corporation, Neenah, WI (US)

(72) Inventor: Tom Gerstner, Sussex, WI (US)

(73) Assignee: MENASHA CORPORATION, Neenah, WI (US)

(21) Appl. No.: 13/657,055

(22) Filed: Oct. 22, 2012

Related U.S. Application Data
(60) Provisional application No. 61/550,968, filed on Oct. 25, 2011.

(51) Int. Cl. G09F 13/00; G09F 25/00; G09F 7/18

(52) U.S. Cl. CPC G09F 13/00; G09F 7/18; G09F 25/00
USPC 40/541; 40/607.15; 40/606.03

(57) ABSTRACT

A display system for use with an end stand or end cap shelving system is provided. The display system is formed from a first blank of material and a second blank of material. The blanks are cut and provided with fold lines, score lines and perforations necessary to fold the blanks into a set up display system. A lighting system can be incorporated into the display system. A side saddle display and product holder is also provided.

### CROSS-REFERENCE TO RELATED APPLICATIONS

The present application claims the benefit of U.S. Provisional Application No. 61/550,968 filed Oct. 25, 2011, the contents of which are incorporated herein.

### FEDERALLY SPONSORED RESEARCH OR DEVELOPMENT

N/A

### FIELD OF THE INVENTION

The present invention generally relates to an end stand display system for placement on shelving typically found at an end of an aisle, and to a side saddle display and product holder that can be used with the end stand display system.

### DESCRIPTION OF THE PRIOR ART

A variety of signage is utilized to advertise and provide information relevant to products sold in the store. New ways of bringing attention to such products are constantly being sought. The present invention provides an innovative signage display system for use on shelving displays in a store, and an additional display and/or product holder.

### SUMMARY OF THE INVENTION

The present invention provides a display system that can be placed on the top shelf of a shelving stand. In particular, the display system can be utilized for an end stand or end cap shelving typically found at the end of an aisle in a store. The display system can be easily assembled and secured to the shelving stand. The display system can be used to advertise and provide information relating to products for sale that can be placed on the shelving system on which the display system is placed. The display system is preferably configured to draw attention from a consumer toward the display system and products displayed on the end stand or end cap at issue.

Additionally, in one embodiment, the display system can include a light display as part of the display system. The light display can include a plurality of LED lights powered by batteries held in a housing positioned behind the display system.

Other than the lighting components, the other main portions of the display system can be formed by paper products, such as paperboard or a corrugated cardboard. Other suitable materials could also be used.

The paper products can be in the form of a first blank and a second blank. The first and second blanks can be cut, scored, perforated or otherwise similarly formed or configured to collectively create the desired structure of the display system.

In accordance with one embodiment, a display system for placement on a shelving system is provided. The display system comprises a first lower back portion having a first slot for connection to a first side wall of a shelf and a second slot for connection to a second side wall of the shelf The display system further includes a second upper back portion having a display panel. A first arm is connected on one side of the display panel. The first arm is foldable to extend over the first side wall. A second arm is connected on a second side of the display panel. The second arm is foldable to extend over the second side wall.

The display system can further comprise a flap connected to the first arm for placement on a forward facing portion of the first side wall. Similarly, the display system can further comprise a flap connected to the second arm for placement on a forward facing portion of the second side wall. Preferably, the display system is positioned on the topmost shelf of an end stand or end cap shelving system.

The display system can further comprise a compartment positioned behind the upper back portion. The compartment can be utilized to house lights, batteries and other related circuitry or switches, for use with the display system. The lights can be LEDs or other similar lights and can be coupled to the batteries via wires. The lights can be positioned in a variety of locations on the display system and are not necessarily limited to being positioned in the compartment.

The first lower back portion can be formed from a first single blank of material. Similarly, the second upper back portion, first arm and second arm can be formed from a second single blank of material. The blanks can be formed from a paperboard or a corrugated material and/or any other suitable materials.

Additionally, the present invention includes a side saddle display and product holder. The products in the holder are removed from an opening in a lower portion of the holder. Accordingly, gravity feeds the next products being held to the opening. The side saddle can attach to the end cap display system described herein.

The side saddle can be formed from a single blank of material that can be folded into the appropriate structure. The side saddle is a generally rectangular hollow structure that can be mounted to an end aisle. The saddle includes an opening proximate a bottom portion exposing product carried in the structure. Removing product from the opening enables any remaining product to slide down (under gravity) and be available through the opening for the next customer.

In accordance with one embodiment of the invention, a side saddle is provided. The side saddle includes a generally rectangular body having a front side wall, a first side wall, a back wall and a second side wall. An opening is formed in a lower portion of the front side wall, first side wall and second side wall allow access and exposure of products contained in the side saddle. A bottom wall including a first tab configured for placement in a slot in the back side wall is also included.

In accordance with another embodiment of the invention, a display system for use on the top of a shelving system having a top shelf with a back wall, a first side wall and a second side wall is provided. The display system comprises a first lower back portion positionable against the back wall of the top shelf and extending from the first side wall to the second side wall. A second upper back portion is connected to the first lower back portion and extends above the first lower back portion. The second upper back portion includes a central portion generally parallel to the first lower back portion. A first arm extends forward from the second upper back portion above the first side wall of the top shelf and, a second arm extends forward from the second upper back portion above the second side wall of the top shelf.

The first lower back portion can include a first slot for connecting the first lower back portion to the first side wall of the top shelf and a second slot for connecting the first lower back portion to the second side wall of the top shelf. Other similar connection means can also be utilized.

The first arm and the second arm of the second upper back portion can be integrally formed with the second upper back portion. The arms can be part of the same blank of material and can be folded forward upon use.

The display system can further comprise an electronics housing compartment. The electronics housing compartment can be formed from an extension of the second upper back portion that is folded into a position behind the second upper back portion. This causes some separation between the second upper back portion and the first lower back portion, such that the second upper back portion is positioned forward of the first lower back portion. The electronics housing compartment can hold batteries and other electronic components used with the display system.

The display system can include lights (e.g., LEDs) electronically connected to the electronics housing compartment. The display system can also include a speaker connected to an audio device in the electronics housing compartment.

In accordance with another embodiment, a display system for use with a shelving system which is formed from a single blank of material is provided. The display system comprises a back portion having a lower portion connectable to a back wall of a top shelf of a shelving system and an upper portion that extends above the back wall of the top shelf. The display system includes a first arm extending forward from a first side of the upper portion of the back portion above a first side wall of the top shelf and, a second arm extending forward from a second side of the upper portion of the back portion above a second side wall of the top shelf

The first and second arms are integrally formed with the back portion. The arms are folded forward and can include flaps to secure the front portion of the arms to the front of the side walls of the shelf.

The display system can further comprise a plurality of pegs for securing the lower portion of the back portion to the back wall of the top shelf Alternatively, other means, such as glue can be used to secure the lower portion of the back portion to the back of the top shelf.

Further aspects of the invention are disclosed in the description of the invention, including the Figures.

### BRIEF DESCRIPTION OF THE DRAWINGS

To understand the present invention, it will now be described by way of example, with reference to the accompanying drawings in which:

FIG. 1 is a perspective view of the end stand display system of the present invention;

FIG. 2 is a blank for forming a first component of the end stand display system of FIG. 1;

FIG. 3 is a is a blank for forming a second component of the end stand display system of FIG. 1;

FIG. 4 is a perspective view of a side saddle display and product holder in accordance with another aspect of the present invention;

FIG. 5 is a plan view of a blank for forming the side saddle display of FIG. 4;

FIG. 6 is a perspective view of another embodiment of an end stand display system in accordance with the present invention; and,

FIG. 7 is blank for forming the end stand display of FIG. 6.

### DETAILED DESCRIPTION

While this invention is susceptible of embodiments in many different forms, there is shown in the drawings what will herein be described in detail preferred embodiments of the invention with the understanding that the present disclosure is to be considered as an exemplification of the principles of the invention and is not intended to limit the broad aspect of the invention to the embodiments illustrated.

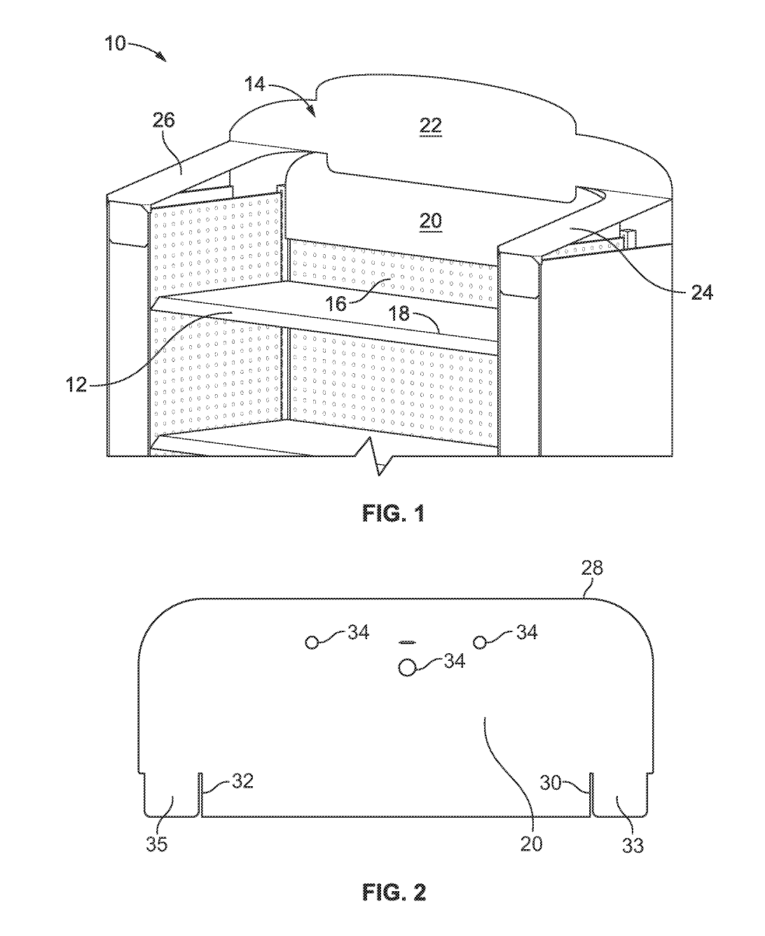

As illustrated in FIG. 1, a display system 10 for placement on the top shelf of a shelving system 12 is shown. The display system 10 is particularly suitable for an end of aisle or end cap display.

The display system 10 includes a back portion 14 designed to be positioned at the back wall 16 of the topmost shelf 18 of the shelving system 12. The back portion 14 of the display system 10 has a lower back wall portion 20 and an upper back wall portion 22. A first arm 24 extends from one side of the upper back wall portion 22 to the front of one side of the topmost shelf 18, and a second arm 26 extends from a second side of the upper back wall portion 22 to a second side of the topmost shelf 18. As is evident in FIG. 1, the upper back wall portion 22 extends slightly away from the lower back portion 20 toward the front of the topmost shelf 18. This slight separation is to accommodate batteries and lights for a light display that can be utilized with the display system 10.

FIG. 2 is a first blank 28 for forming a first component of the display system 10 of FIG. 1. The first blank 28 forms the lower back wall portion 20 of the back portion 14 of the set up display system 10. The first blank 28 is generally rectangular with rounded upper corners. The first blank 28 includes a first slot 30 and a second slot 32 in a lower portion of the first blank 28. The first and second slots 30, 32 are used to slide the first blank 28 over a first side wall and a second side wall of the topmost shelf 18, respectively. A first tab segment 33 and a second tab segment 35 are positioned between the respective slots 30, 32 and the first side and second side of the first blank 28. The tabs 33, 35 are sized and configured to be placed between an inner wall and an outer wall of the first and second side walls of the topmost shelf 18 when such walls are of double walled construction.

The first blank 28 includes a plurality of apertures 34. The apertures 34 can be utilized with connectors to secure the first blank 28 to other components of the display system 10.

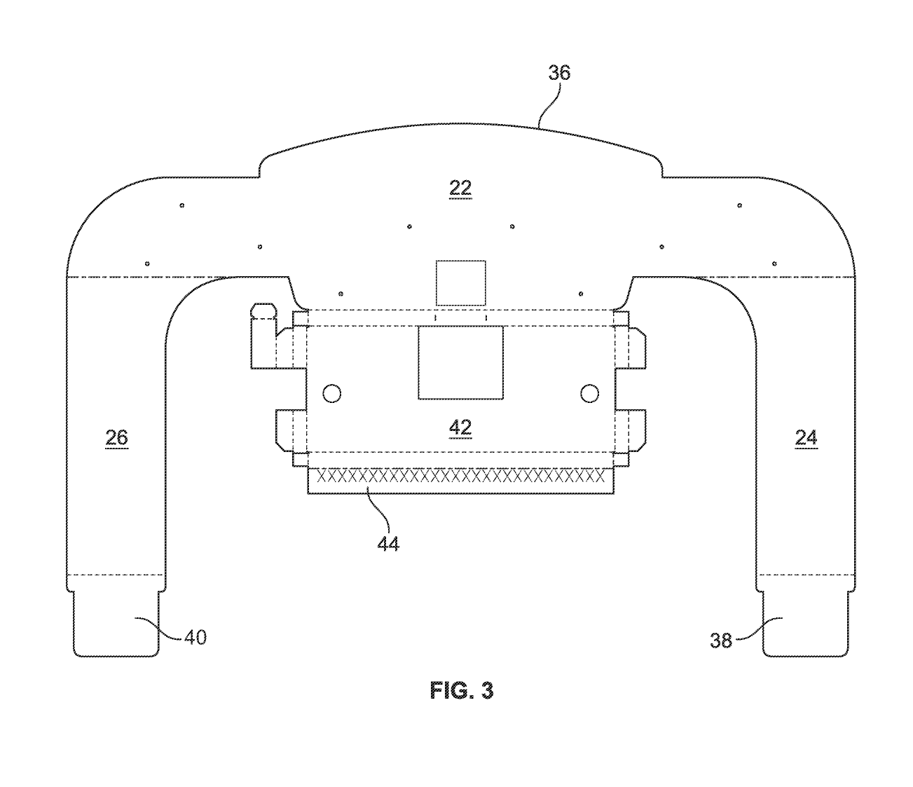

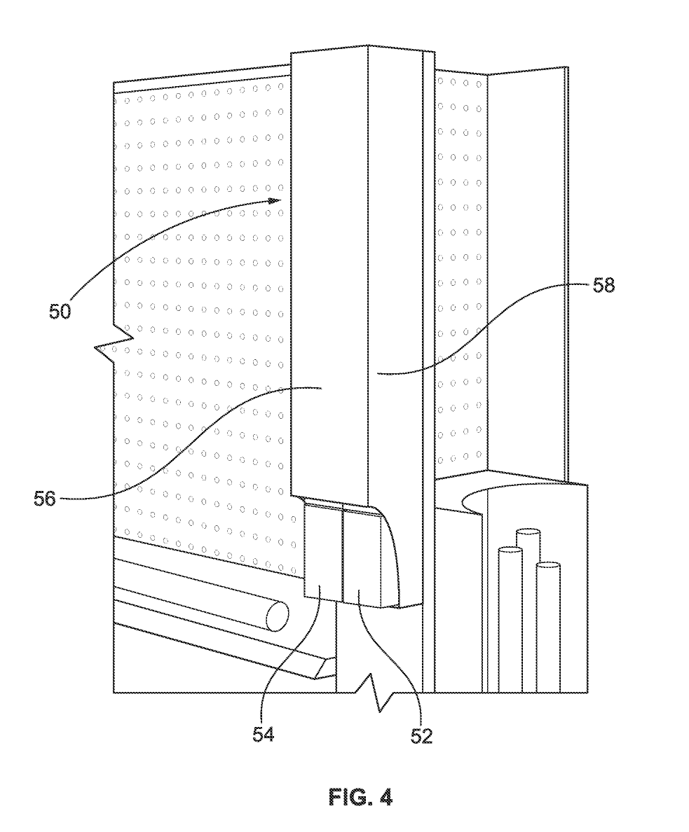

FIG. 3 shows a second blank 36 for forming a second component of the display system 10 of FIG. 1. The second blank 36 forms the upper back wall portion 22 of the back portion 14 of the display system 10 when set up. The second blank 36 also includes and forms the first arm 24 and the second arm 26 of the set up display system 10. The first arm 24 includes a downward flap 38 at a distal end of the first arm 24. The second arm 26 similarly includes a downward flap 40 at a distal end of the second arm 26. The downward flaps 38, 40 can be used to secure the arms 24, 26 to the front of the side walls of the topmost shelf 18.

The second blank 36 also includes a foldable compartment 42 connected to and extending below the upper back portion 22 that is used to house batteries, light assemblies and related circuitry and switches, which can be used with the display system 10. The foldable compartment 42 includes suitable score and/or fold lines, and a glue panel 44 (glue is indicated by “XXXX . . . ” pattern) to fold and create the compartment for placement behind the upper back portion 22. Lights (such as LEDs) can be positioned throughout the display system and be electrically connected to the batteries in the compartment. Similarly, a speaker can be placed on the display system (or in the compartment) and be set up to provide audible information or music. A motion detector can be utilized with the other electronic components of the system. The compartment can hold switches and other circuitry for operating the lights or speaker.

Graphics, illustrations, product information, etc. can be displayed on the display system 10. Products advertised or promoted by the display system 10 can be placed on the shelving system immediately below the display system.

Referring to FIG. 4, a side saddle display and product holder 50 (hereafter “side saddle”) is shown. The side saddle 50 can be connected to or, in some embodiments, located next to or proximate the display system 10 discussed above.

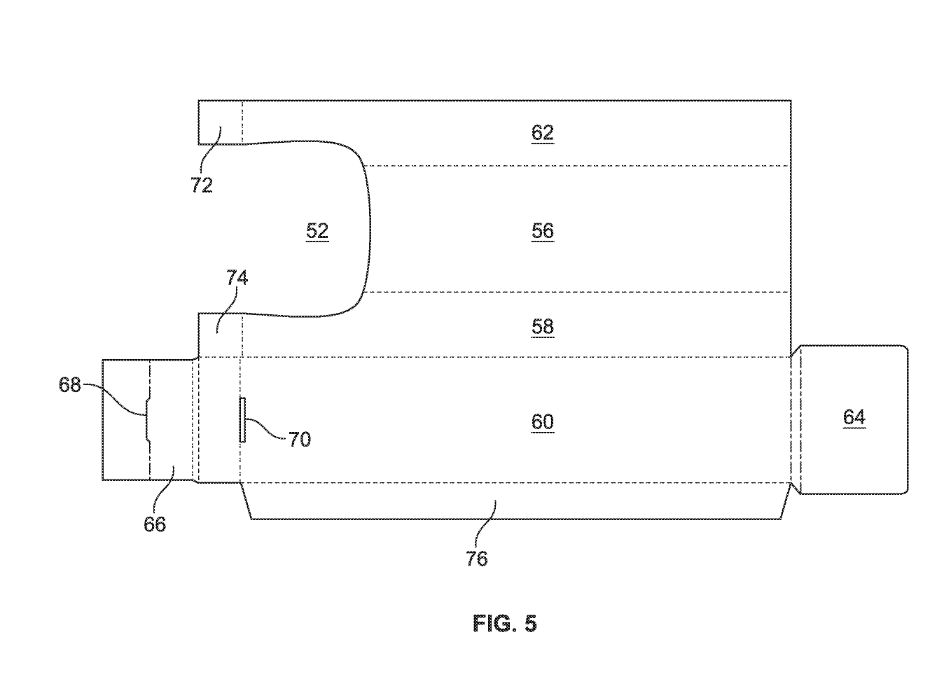

The side saddle 50 is a generally rectangular hollow container having a lower opening 52 for exposing products 54 contained in the interior of the side saddle 50. The lower most products 54 are shown in the opening 52. Other products are positioned in the interior of the container above the lower most products. The side saddle 50 can be formed from a single blank of material like that shown in FIG. 5.

Referring to both FIGS. 4 and 5, the side saddle 50 includes a first or front side wall 56, a second side wall 58, a third or back side wall 60, and a forth side wall 62. The opening 52 is formed in a lower portion of the first side wall 56, as well as portions of the second side wall 58 and fourth side wall 62. The side saddle 50 includes a top 64.

The side saddle 50 also includes a bottom wall 66 extending from a lower portion of the third or back wall 60. As shown in FIG. 5, the bottom 66 includes a foldable panel having a tab 68 that is inserted into a slot 70. The bottom 66 is designed to be sturdy to support the products 54 contained in the side saddle 50. Flaps 72 and 74 extending from a lower portion of the second sidewall 58 and the fourth side wall 62, respectively, are also used as part of the bottom of the side saddle 50.

The blank for forming the side saddle 50 can be die cut to the desired shape and provided with appropriate fold and/or score lines to enable one to easily assemble the blank into the set up side saddle 50 display. A glue tab or panel 76 can be provided along one side wall (e.g., the back wall 60) for connecting the side walls. All of the side walls and panels are integrally connected because the blank is formed from a single sheet of material.

The side saddle 50 can contain graphics, illustrations, product information, etc., on one or more of the side walls. The side saddle 50 can be formed from paperboard, cardboard, or other similar or suitable materials.

In operation, once set up, the side saddle is filled with products 54. When placed for use in a store, removal of products 54 from the opening 52 allows additional products in the side saddle to move down (under gravity) and replace the removed products in the opening 52.

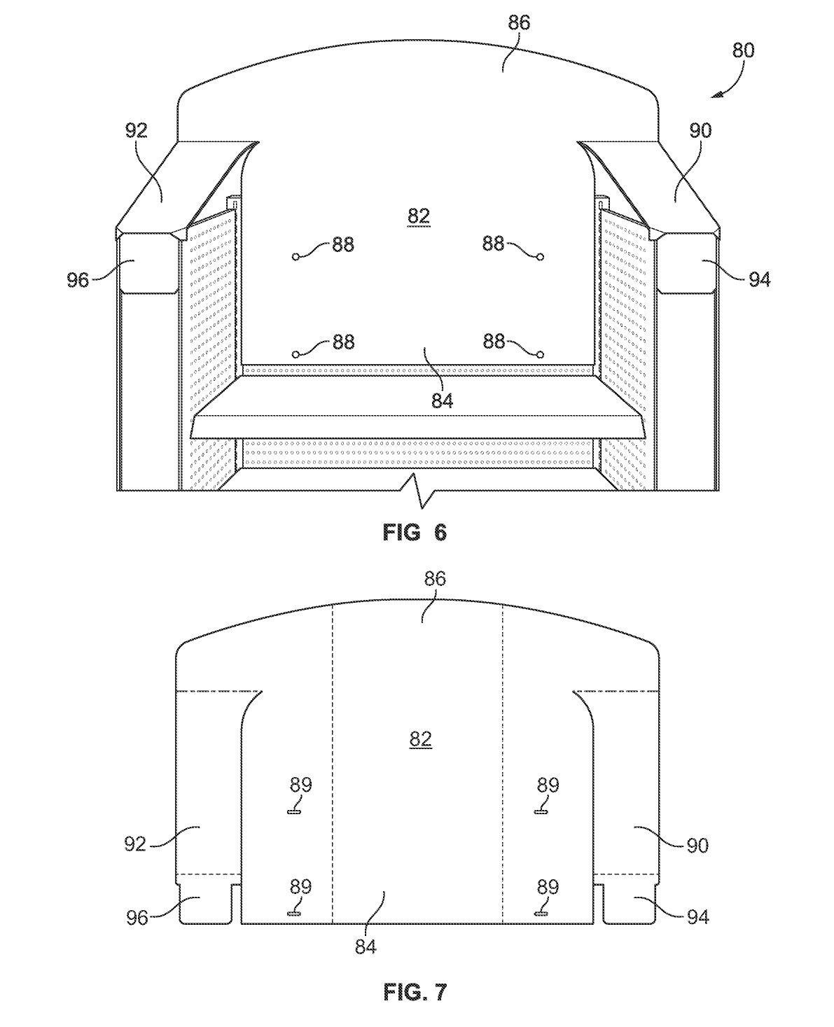

FIGS. 6 and 7 illustrate another embodiment of an end display system 80 of the present invention. As shown, the end display system 80 is formed from a single blank of material. The end display system includes a back portion 82 that includes a lower back portion 84 that contacts the back of the top shelf, and an upper back portion 86 that extends upward above the back wall of the top shelf.

The lower back portion 84 is connected to the back wall of the top shelf by pegs 88 (e.g., pins, nails, tacks, etc.). As illustrated in FIG. 7, the blank is provided with apertures or slots 89 for the pegs. Other conventional means, such as clips, glue, etc. can be used to secure the lower back portion 84 to the shelf.

The end display system 80 includes a first arm 90 that extends over the first side wall of the top shelf, and a second arm 92 that extends over the second side wall of the top shelf Each arm 90, 92 includes a flap 94, 96, respectively, that can be used to secure the front of the arm to the shelf

As shown, the arms 90, 92 are integrally formed with the back portion 82 and are folded forward. Similar to the first embodiment of the end display system 10, the fold lines are positioned higher than the side walls of the shelf so that the arms slant downward.

Although not shown, the end display system 80 can include graphics and other indicia as desired to promote goods and/or services.

Many modifications and variations of the present invention are possible in light of the above teachings. It is, therefore, to be understood within the scope of the appended claims the invention may be protected otherwise than as specifically described.

I/we claim:

1. A display system for placement on a shelving system comprising:
a first lower back portion having a first slot for connection to a first side wall of a shelf and a second slot for connection to a second side wall of the shelf;
a second upper back portion having a display panel connected to the first lower back portion, a first arm connected on one side of the display panel, the first arm foldable to extend over the first side wall, and a second arm connected on a second side of the display panel, the second arm foldable to extend over the second side wall.

2. The display system of claim 1 further comprising a flap connected to the first arm for placement on a forward facing portion of the first side wall.

3. The display system of claim 1 further comprising a flap connected to the second arm for placement on a forward facing portion of the second side wall.

4. The display system of claim 1 further comprising a compartment positioned behind the upper back portion, the compartment housing lights and batteries for use with the display system.

5. The display system of claim 1 wherein the first lower back portion is formed from a first single blank of material.

6. The display system of claim 5 wherein the second upper back portion, first arm and second arm are formed from a second single blank of material.

7. The display system of claim 6 wherein the first single blank and the second single blank are formed from paperboard.

8. The display system of claim 6 wherein the first single blank and the second single blank are formed from a corrugated material.

9. The display system of claim 1 further comprising:
a side saddle having a generally rectangular body having a front side wall, a first side wall, a back wall and a second side wall, an opening in a lower portion of the front side wall, first side wall and second side wall, a bottom wall including a first tab configured for placement in a slot in the back side wall.

10. The display system of claim 9 wherein the body of the side saddle is formed from a blank formed from a single sheet of material.

11. A display system for use with a shelving system comprising:
a back portion having a lower portion connectable to a back wall of a top shelf of a shelving system and an upper portion that extends above the back wall of the top shelf;
a first arm extending forward from a first side of the upper portion of the back portion above a first side wall of the top shelf; and,
a second arm extending forward from a second side of the upper portion of the back portion above a second side wall of the top shelf

12. The display system of claim 11 wherein the first arm and the second arm are integrally formed with the back portion.

13. The display system of claim 11 further comprising a plurality of pegs for securing the lower portion of the back portion to the back wall of the top shelf.

14. A display system for use on the top of a shelving system having a top shelf with a back wall, a first side wall and a second side wall, the display system comprising:
a first lower back portion positionable against the back wall of the top shelf and extending from the first side wall to the second side wall;
a second upper back portion connected to the first lower back portion and extending above the first lower back portion, the second upper back portion including a central portion generally parallel to the first lower back portion;
a first arm extending forward from the second upper back portion above the first side wall of the top shelf; and,
a second arm extending forward from the second upper back portion above the second side wall of the top shelf.

15. The display system of claim 14 wherein the first lower back portion includes a first slot for connecting the first lower back portion to the first side wall of the top shelf and a second slot for connecting the first lower back portion to the second side wall of the top shelf

16. The display system of claim 14 wherein the first arm and the second arm are integrally formed with the second upper back portion.

17. The display system of claim 14 further comprising an electronics housing compartment.

18. The display system of claim 17 wherein the electronics housing compartment is formed from an extension of the second upper back portion and is foldable to a position behind the second upper back portion.

19. The display system of claim 18 further comprising lights connected to the electronics housing compartment.

20. The display system of claim 18 further comprising a speaker connected to the electronics housing compartment.
